(19) United States
(12) Patent Application Publication
(10) Pub. No.: US 2007/0106879 A1
(43) Pub. Date: May 10, 2007

(54) Semiconductor device

(75) Inventor: Hiroshi Tanaka, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/593,609

(22) Filed: Nov. 7, 2006

(30) Foreign Application Priority Data
Nov. 8, 2005 (JP) 2005-323002

(51) Int. Cl. G06F 9/30

(52) U.S. Cl. 712/214

(57) ABSTRACT

A semiconductor device that comprises a dynamic reconfigurable processor that changes functions thereof by changing configuration data and executes a plurality of threads in a time-sharing mode, wherein the dynamic reconfigurable processor FE has a thread management table having a plurality of flag registers for each thread that indicate whether a corresponding thread is in an executable state, and a sequencer SEQ that controls the thread change based on the information of the thread management table, and wherein the sequencer changes the thread by referring to the content of the plurality of flag registers.

### INCORPORATION BY REFERENCE

The present application claims priority from Japanese application JP2005-323002 filed on Nov. 8, 2005, the content of which is hereby incorporated by reference into this application.

### BACKGROUND OF THE INVENTION

The present invention relates to a semiconductor device that is capable of dynamically changing configuration information, and more particularly, to a semiconductor device that is particularly useful in reducing overhead of a semiconductor device which is provided with a configuration management and a processor for managing the same.

In recent years, with the proliferation and higher performance of information processing equipment, various applications as well as various formats have been emerging. For example, one video compression format would include a number of formats, such as MPEG 1, MPEG 2, MPEG 4, H.264, Windows™ media, or the like.

However, there exists such a problem that in order to implement the recent video compression format, processors need to have versatility and high processing performance, thus making it difficult for general purpose processors that are currently used for embedded devices to implement the video compression format. In addition, these days, the size of circuit capable of being processed by an LSI has increased due to the development in semiconductor technology, and thereby the LSI is required that effectively utilizes large circuits.

Examples for solving the above problems are disclosed in JP-A-10-4345 and U.S. Pat. No. 6,738,891 (corresponds to JP-A-2001-312481). In the examples, the problems are solved through the use of the LSI that changes operations by changing configuration information which specifies how a hardware, such as represented by a dynamic reconfigurable processor, is constituted.

Such prior arts provide a control structure for executing autonomous and dynamic reconfiguration without any involvement by other controllers. However, although provided with a support for a branch, the control structure is basically a sequential control mechanism. Therefore, it is difficult for the control structure the way it is to execute multi-task processing, which has become important for embedded devices these days, or real time processing.

In the conventional method described in the JP-A-10-4345 and U.S. Pat. No. 6,738,891, an external control processor or a relatively simple sequencer was used to control the dynamic reconfiguration, and a simple status transition or branch was used to control threads. Therefore, in multi-task processing for executing a plurality of tasks simultaneously, the control processor had to execute complicated thread control. As used herein, the term “thread” represents a processing that is executed with one piece of configuration data of the dynamic reconfiguration processor. Furthermore, the task is constituted by a plurality of threads.

In this case, when changing threads, the dynamic reconfiguration processor interrupts the control processor. The control processor must assess the circumstances to determine a thread to be executed next, and must inform the dynamic configuration processor, thus incurring a large overhead.

The overhead includes an interruption processing by the control processor, processing for determining a thread to be executed next, communication time between the control processor and the dynamic reconfiguration processor, latency time until the dynamic reconfiguration processor executes next thread, or the like, which causes the entire chip performance to deteriorate.

It is considered that as the embedded devices become more complicated and more various functions are mounted thereon from now on, aforementioned multitask related problems will become more significant. It is because, in multitask, frequent changes occur between tasks, and CPU must execute the above processing at each change.

### SUMMARY OF THE INVENTION

It is an object of the present invention to provide a function that facilitates the implementation of multitask in the use of the dynamic reconfiguration processor to reduce overhead when performing multitask processing and to enable the more efficient use of chips.

The following is a brief description of the gist of the representative elements of the invention laid open in the present application.

A sequencer for managing the thread of the dynamic reconfiguration processor comprises a thread management table, and a thread change management table. The thread represents a processing executed with one piece of configuration data for performing dynamic configuration.

The thread management table comprises thread numbers, valid thread flags, configuration addresses, priority, configuration load flags, statuses, flag resisters, flag mask resisters, mask setting registers, and flag reset mask registers.

The thread change table comprises thread change numbers, thread change valid flags, former threads, latter threads, thread change interrupts, and thread changing conditions.

The configuration and scheme according to the present invention enable a reduction in overhead when a chip that includes the dynamic reconfigurable processor executes multitask processing.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing a chip configuration as one embodiment of the present invention;

FIG. 2 is a view showing the module configuration of a dynamic reconfigurable processor FE as one embodiment of the present invention;

FIG. 3 is a view showing the content of processing for use in explaining the operation of the present invention;

FIG. 4 is a view showing the configuration of a thread management table as one embodiment of the present invention;

FIG. 5 is a view showing the operation associated with a change in a flag register of the thread management table as one embodiment of the present invention;

FIG. 6 is a view showing the configuration of the thread change management table as one embodiment of the present invention;

FIG. 7 is a view showing the operation associated with a change in the changing condition of the thread change management table as one embodiment of the present invention;

FIG. 8 is a view showing the operation associated with a change in the status of the thread management table as one embodiment of the present invention;

FIG. 9 is a view showing an exemplary operation when the processing shown in FIG. 3 is performed by a conventional configuration;

FIG. 10 is a view showing an exemplary operation when the processing shown in FIG. 3 is performed through the use of the present invention; and

FIG. 11 is a view showing a second configuration of the thread management table as one embodiment of the present invention.

### DESCRIPTION OF THE EMBODIMENTS

Representative embodiments according to the present invention will be described in detail with reference to drawings in the following sections. It should be noted that like reference numerals and characters represent like or similar components in the following description.

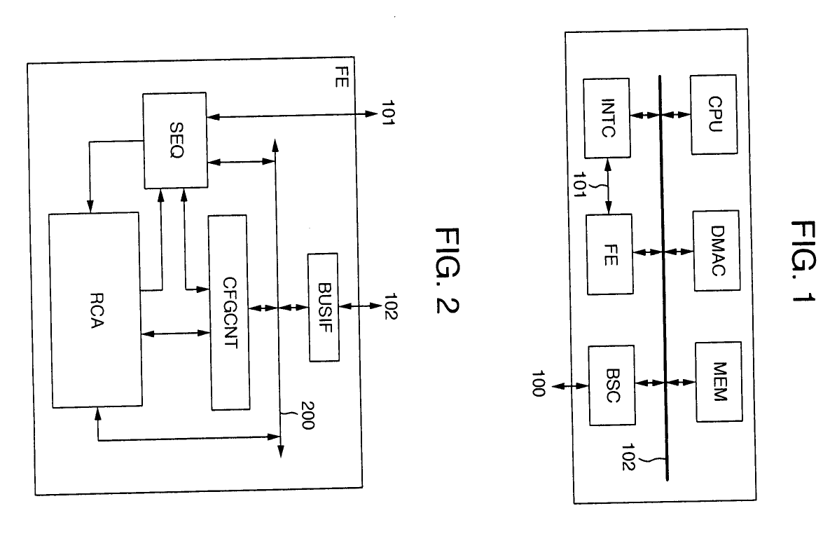

FIG. 1 shows an exemplary chip configuration targeted by the present invention. The chip shown in FIG. 1 comprises a CPU, a direct memory access controller DMAC, an interruption controller INTC, a dynamic reconfigurable processor FE, an on-chip memory MEM, and a bus state controller BSC. These 6 modules are connected to a processor bus 102.

The CPU is a main processor in the chip and manages other modules and performs programmed principal processing. The interruption controller INTC is a module for managing the interruption to the CPU. The interruption controller INTC receives all interruptions to the CPU, and determines priority to make a decision on an interruption to be notified. An interruption wire 101 of the dynamic reconfigurable processor FE is connected to the interruption controller INTC. While actually signals are outputted also from other modules to the interruption controller, description thereof is omitted here, since they have little association with the present invention. The direct memory access controller DMAC is a module for transferring data without using the CPU. Data can be automatically transferred by transmitting start-up signals after the CPU is set. The dynamic reconfigurable processor FE is a processor characterized in that it has a plurality of computing units as well as high performance. In the present embodiment, initial setting starts from the CPU, and once it is started, the dynamic reconfigurable processor FE operates automatically following set data. The on-chip memory MEM is used for processing by the CPU. The bus state controller BSC manages the processor bus 102, bridges data between the external bus 100 and processor bus 102, and performs other things.

FIG. 2 shows an exemplary module configuration of the dynamic reconfigurable processor FE. The dynamic reconfigurable processor FE comprises a bus interface BUSIF, a configuration controller CFGCNT, a dynamically reconfigurable cell array RCA, a sequencer SEQ, and an internal bus within the FE 200.

The bus interface BUSIF is connected to a processor bus 102 and the internal bus 200, and passes message between the busses. The configuration controller CFGCNT follows instructions from the sequencer SEQ to transmit configuration data to the dynamically reconfigurable cell array RCA. As used herein, the term “configuration data” refers to reconfiguration information of the dynamically reconfigurable cell array RCA. The configuration controller CFGCNT internally comprises a configuration buffer and is capable of storing a lot of configuration data. In the present embodiment, a method is assumed in which the transmission of data from the outside of the dynamic reconfigurable processor FE to the configuration buffer is performed by other modules than the dynamic reconfigurable processor FE, such as the CPU, or direct memory access controller DMAC. However, a scheme is also possible in which the configuration controller CFGCNT automatically loads the configuration data in the same manner as a cache of the CPU. The configuration data is stored in the on-chip memory MEM or an external memory. Since only necessary configuration data is stored in the configuration buffer, the capacity of the configuration buffer can be reduced. The dynamically reconfigurable cell array RCA comprises a plurality of computing cells for performing computation, an internal memory, a load store cell for supporting the communication between the internal memory and the computing cell, and a wiring for connecting each cell. While the internal configuration of the dynamically reconfigurable cell array RCA is not particularly limited in the present invention, it is characterized in that high speed reconfiguration can be performed through the use of the configuration data, and computation is carried out using data of the internal memory.

The sequencer SEQ is a main module of the present invention for controlling the dynamic reconfigurable processor FE. Depending on setting, the sequencer SEQ instructs the configuration controller CFGCNT to load configuration data, activates and terminates the dynamically reconfigurable cell array RCA, instructs to change configurations, and manages the configuration changes. The sequencer SEQ comprises a thread management table, a thread change management table, and an interruption factor register. The content of these tables as well as operations using the content will be described later.

The term “thread” used in the present embodiment refers to processing executed through the use of one piece of reconfiguration data of the dynamically reconfigurable cell array RCA. The dynamic reconfigurable processor FE is capable of executing various processing by changing threads.

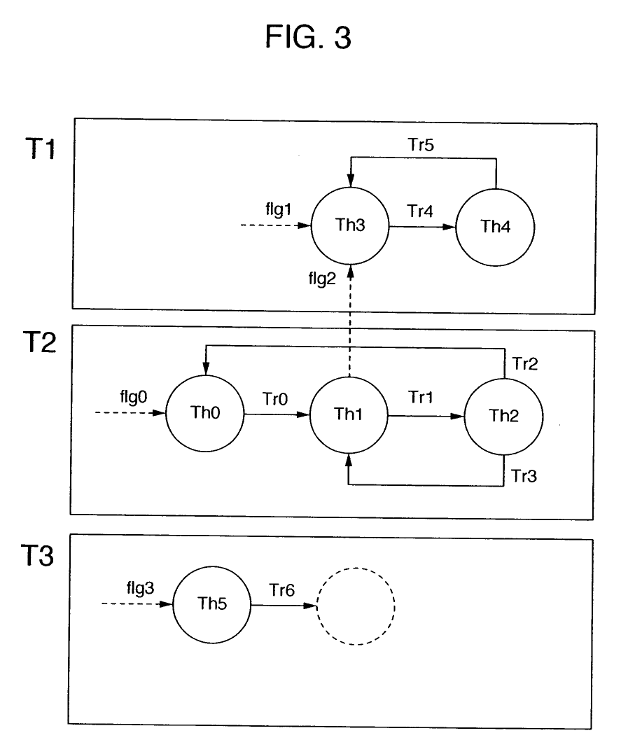

FIG. 3 is a view showing the content of processing examples that are used for subsequent explanations. In FIG. 3, circles indicate threads, solid arrows indicate thread changes, dotted arrows indicate a set of flags as implementation conditions, and squares indicate tasks. Each task comprises threads and thread changes, and operates with internal conditions and a set of flags from the outside of the dynamic reconfigurable processor FE. Processing shown in FIG. 3 comprises three tasks, T1, T2 and T3.

The task T1 comprises two threads, a thread Th3 and a thread Th4. A thread change Tr4 indicates a change from the thread Th3 to thread Th4, and a thread change Tr5 indicates a change from the thread Th4 to thread Th3. A start-up condition for the thread Th3 is that following three flags are set: a flag that is set by the thread change Tr5, a flag flg1 that is set from the outside of the dynamic reconfigurable processor FE, and a flag flg2 that is set by the task T2. A startup condition for the thread Th4 is a flag that is set by the thread change Tr4.

The task T2 comprises three threads, a thread Th0, a thread Th1, and a thread Th2. A thread change Tr0 indicates a change from the thread Th0 to the thread Th1, a thread change Tr1 indicates a change from the thread Th1 to thread Th2, a thread change Tr2 indicates a change from the thread Th2 to thread Th0, and a thread change Tr3 indicates a change from the thread Th2 to thread Th1. A startup condition for the thread Th0 is any of the thread change Tr2 or a flag flg0 that is set from the outside of the dynamic reconfigurable processor FE is set. A startup condition for the thread Th1 is a flag that is set by any of the thread change Tr0 or the thread change Tr3. A startup condition for the thread Th2 is a flag that is set by the thread change Tr1.

The task 3 comprises only a thread Th5. A thread change Tr6 indicates the termination of the thread Th5. A startup condition for the thread change Tr5 is a flag flg3 that is set from the outside of the dynamic reconfigurable processor FE.

Here, the task T3 has the highest priority, followed by the task T1, and task T2. When a plurality of tasks are in an executable state, the task having the highest priority is executed.

Operations will be described in the following sections using the processing content illustrated in FIG. 3. While it does not particularly represent the execution of a specific application, the processing content illustrated in FIG. 3 uses the characteristic in a case where a plurality of tasks are simultaneously executed. For example, the task T1 and task T2 apply to a case in which video and audio are simultaneously decoded while being synchronized in video playback. The task 3 applies to a case in which a timer interruption is used to drive a specific sensor or hardware.

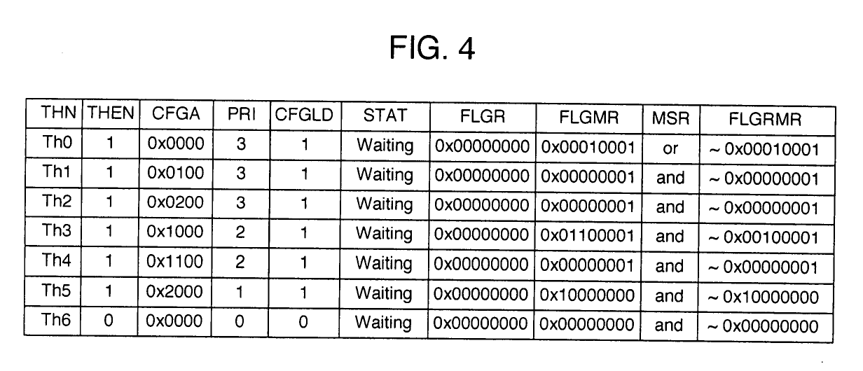

FIG. 4 is a view illustrating a thread management table as a component of the sequencer SEQ. The table comprises a thread number THN, a valid thread flag THEN, a configuration address CFGA, a priority order PRI, a configuration load flag CFGLD, a status STAT, a flag resistance FLGR, a flag mask register FLGMR, a mask setting register MSR, and a flag reset mask register FLGMR.

The thread number THN is a number for identifying the threads. The thread numbers of FIG. 4 corresponds to those of FIG. 3, with other settings being similarly configured to represent the operation of FIG. 3. However, the thread Th6 is not used in the processing illustrated in FIG. 3.

The valid thread flag THEN sets whether the definition of the thread is valid or not. During execution of reset, the thread has a value representing invalidness and has a value representing validness after other values are set. This is because during the execution of reset, it can not be determined whether the information stored in the thread management table is accurate or not. The setting in this manner enables the prevention of a runaway caused by inaccurate data. It should be noted that validness is set to 1, while invalidness is set to 0 in the present embodiment. 1 is set to threads Th0 through Th5 which are used here, while 0 is set to the thread Th6 which is not used here.

The configuration address CFGA indicates addresses in the configuration buffer within the configuration controller CFGCNT in which configuration data corresponding to the threads is stored. Instead of having the configuration data in the management table, the address of the configuration buffer, in which the configuration data is stored, is held. This enables different threads to use the same configuration data, and thereby enables a reduction in the area of the dynamic reconfigurable processor compared with having the configuration data for each thread. It should be noted that the address is configured in 16 bits and is represented in hexadecimal in the present embodiment. “0x” is a prefix indicating hexadecimal.

The PRI indicates priority of threads. It is possible to assign the same priority to a plurality of threads. In the present embodiment, the closer the value is to 1, the higher priority the thread has. However, 0 is invalid here. For example, when a thread having priority 1 and a thread having priority 2 are in an executable state, the thread having priority 1 is executed. Therefore, priority 3 is assigned to the threads Th0 through Th2, while priority 2 is assigned to the threads Th3 as well as Th4, and priority 1 is assigned to the thread Th5. Furthermore, a predetermined priority is set as invalidness, and predetermined information is registered to a certain thread management number THN. As a result, it is possible make a setting that while a thread is valid in the valid thread flag TNEN, it is invalid in the priority flag PRI. Therefore, a change of the priority flag PRI from “valid” to “invalid”, or vice versa, would make is possible to configure such that while the information stored in the thread management number THN is valid, it is not used currently. In addition, it would be possible to assign priorities in the order of thread number THN in a fixed manner (for example, such that Th0 has the highest priority). However, the capability to assign priorities in such a manner as described in the present embodiment would enable users to dispose threads in the thread management table as they want, thus improving convenience.

A configuration load flag CFGLD indicates whether configuration data corresponding to the threads exists in the configuration buffer or not. This obviates the need for storing all configuration data in the configuration buffer, and thereby enables a reduction in the capacity of the configuration buffer. Here, when there exists configuration data, it is indicated by 1, and when there exists no configuration data, it is indicated by 0. For example, when all of the configuration data corresponding to the threads that are desired to be executed are not accommodated in the configuration buffer, it is necessary to perform management using the configuration load flag CFGLD and to replace the configuration buffer using the CPU or DMAC at an appropriate timing. Since the present embodiment assumes a state in which all configuration data is previously loaded, 1 is entered in the configuration load flag CFGLD for the threads Th0 through Th5. Since the configuration load flag CFGLD is configured be rewritable even during operation, the configuration data can be transferred to the configuration buffer in the background.

A status STAT indicates the status of the threads. The status STAT can take three statuses, Waiting, Ready, and Running. Waiting represents a status in which a thread is not ready for being executed. Ready is a status in which the thread is ready for being executed, or in an executable status. Running represents a status in which the thread is being executed. A method of managing the status will be described later. In the present processing embodiment, all initial values are set to Waiting.

A flag register FLGR is a register for setting whether a condition necessary for the execution of the thread is satisfied or not. In the present embodiment, it is configured such that when the condition is satisfied, 1 is entered, while when the condition is not satisfied, 0 is entered. The register is updated, regardless of whether it is working or not, by a module within the FE (e.g. reconfigurable cell array RCA) and a module outside the FE (e.g. CPU). The capability of updating the register from the module inside the FE enables the dynamic reconfigurable processor to autonomously indicate that the condition necessary for the corresponding threads to be executed is satisfied without using the CPU. Moreover, the capability of updating the register from the module outside the FE, regardless of whether the register is working or not, enables the module outside the EF (e.g. CPU) to update the register at a timing convenient to the module regardless of the FE's status.

In addition, while 32 bits are assigned to the register in the present embodiment, the 0-th bit (lowest bit) is assigned with a function such that it is particularly set by a thread change. More specifically, for example, when a series of processing are divided into three threads as T2 in FIG. 3, the termination of processing of thread 0 serves as a condition for the thread 1. The condition of the 0-th bit of the flag register FLGR of the thread 1 is satisfied when “1” is set during the termination of the thread 0. Therefore, it is possible to divide a series of processing into a plurality of threads. Users can assign factors to other bits as they desire.

A flag mask register FLGMR is a register for setting which bit of the flag register FLGR to refer to. In the present embodiment, 1 is assigned to a case in which a reference is made, while 0 is assigned to a case in which no reference is made. In the present processing example, the 16th bit of the thread Th0 corresponding to the flg0, the 20th bit of the thread Th3 corresponding to the flg1, the 24th bit of the thread Th3 corresponding to the flg2, and the 28th bit of the thread Th5 corresponding to the flg3 are configured to be valid in addition to the thread change caused least significant bit. The least significant bid for the thread Th5 is set to 0, since it does not use the thread change caused factors. The provision of the flag mask register FLGMR enables the threads, which are brought into an executable state by different conditions, to be used by being replaced with the same management numbers.

A mask setting register MSR is a register for setting how to handle the bits that are specified by the flag register FLGR. For example, when a value indicating “or” is in the register, all bits logic OR of the bits specified by the flag mask register FLGMR in the flag register FLGR is calculated, and if the result is 1, then the status STAT is changed to Ready. Furthermore, when a value indicating “and” is in the register, all bits logic AND of the bits specified by the flag mask register FLGMR in the flag register FLGR is calculated, and if the result is 1, then the status STAT is changed to Ready. By having the mask setting register MSR, users can set the above flag register FLGR as well as flag mask register FLGMR, or the users can set timing at which to bring threads into an executable state as the they desire, thus making it possible to increase information that can be stored in the thread management table. For example, when changing threads based on any one of a condition A and a condition B, if just the and condition is taken, it becomes necessary to store each of the thread change based on the condition A and thread change based on the condition B in different thread management numbers. However, if the or condition can also be taken, it becomes possible to store the thread changes in one thread management number.

A flag reset mask register FLGRMR is a register for setting which bit in the flag register FLGR to reset when the status STAT makes a transition from Waiting to Ready. Here, “˜0x00010001” represents a complement number of 1 (bit inversion) of “0x00010001”. When the status STAT makes a transition from Waiting to Ready, the logic AND for the flag reset mask register FLGRMR and flag register FLGR is taken, and the result is set to the flag register FLGR. In the present processing example, all flags except the thread Th3 are configured to be reset. For the thread Th3, only the flg2 caused bit is configured not to be reset. By having the flag reset mask register FLGRMR, for example, the thread Th3 is started for the first time when two conditions are satisfied: a condition C that a predetermined processing has been finished, and a condition D of external factors. During the startup of the Th3 for the second time or later, change can be performed based on only the condition D of external factors, thus a higher degree of flexibility being provided.

The flag register FLGR and configuration load flag CFGLD of the thus far described thread management table can always be rewritten including even when they are in the midst of operations. In addition, other elements can also be rewritten at every time as long as the valid thread flag TNEN is set to be invalid. To put it the other way around, when the valid thread flag TNEN is valid, elements cannot be rewritten with the exception of the flag register FLGR and configuration load flag CFGLD.

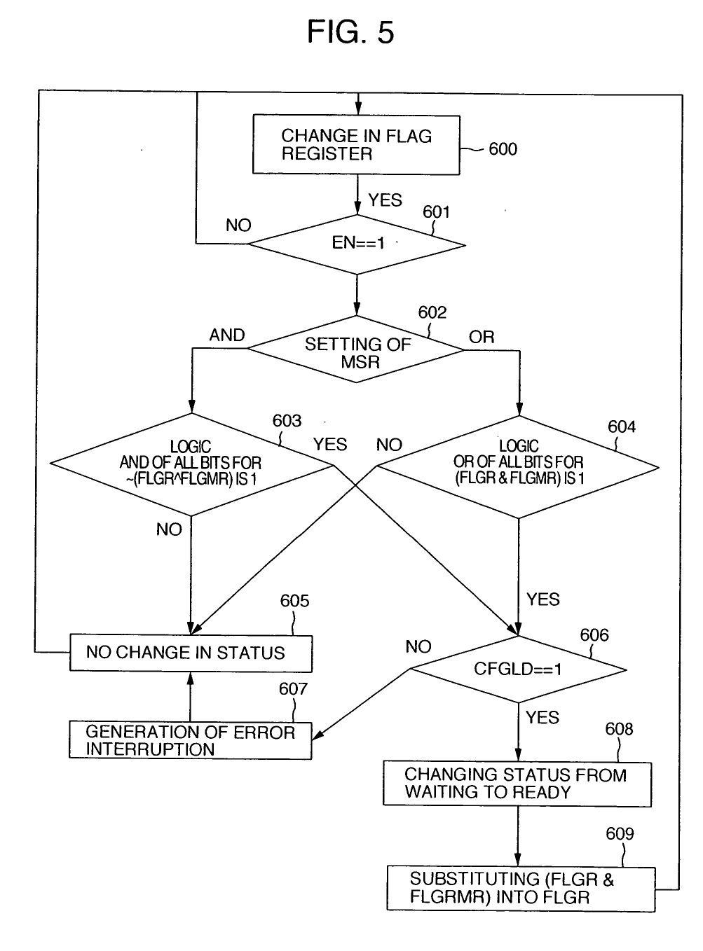

FIG. 5 is a flow chart illustrating the operation relating to the flag register FLGR, and the operation of changing from Waiting to Ready in the status STAT management of the thread management table shown in FIG. 4. The processing illustrated in the flow chart is executed for each thread independently.

At 600, the process of the flow chart starts with a change in flag register FLGR as a trigger. At 601, when the valid thread flag TNEN has a value (1) that indicates validness, the process proceeds to 602, and when it has a value (0) that indicates invalidness, the process returns to 600. Here, when the valid thread flag TNEN has the value indicating invalidness, an error message, which means that the valid thread flag TNEN is invalid, may be transmitted to the CPU, or may not be transmitted, depending on mounted applications. In this case, a change can be made by an application that is processed by the dynamic reconfigurable processor, if a flag is added for each thread management number that indicates whether the error message has been transmitted or not.

At 602, if the value of the mask setting register MSR is “and”, the process proceeds to 603, while if it is “or”, the process proceeds to 604. At 603, an exclusive logical OR of the flag register FLGR and flag mask register FLGMR is obtained, and all bits are reversed. If the result after the logical AND of all the resultant bits is obtained is 1, then the process proceeds to 606, while if the result is 0, then the process proceeds to 605.

At 604, a logical AND of the flag register FLGR and flag mask register FLGMR is obtained, and if the result after the logical OR of the resultant all bits is obtained is 1, then the process proceeds to 606, and if it is 0, then the process proceeds to 605. At 605, since there is no change in the status STAT, the process returns to 600. At 606, if the configuration load flag CFGLD has 1, or corresponding configuration data exists in the configuration buffer, then the process proceeds to 608. If configuration load flag CFGLD has 0, then the process proceeds to 607. At 607, an error interruption is generated which indicates that configuration data corresponding to the thread is not loaded, and the process proceeds to 605.

At 608, the status STAT is changed from Waiting to Ready, and the process proceeds to 609. At 609, the result after the logical AND of the flag register FLGR and flag mask register FLGMR is obtained is substituted into the flag register FLGR, and the process returns to 600.

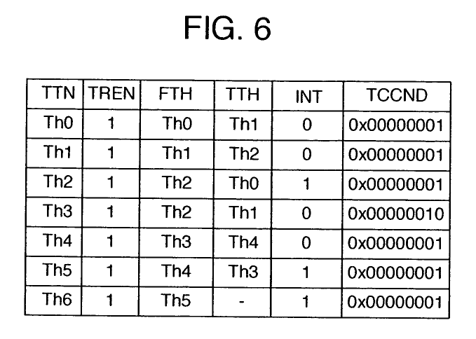

FIG. 6 is a view showing a thread change management table as one component of the sequence SEQ. The thread change management table comprises a thread change number TTN, a thread change valid flag TREN, a former thread FTH, a latter thread TTH, a thread change interrupt INT, and a thread changing condition TCCND.

The thread change number TTN is a number for identifying the thread change. The thread change number TTN shown in FIG. 6 corresponds to the thread change number shown in FIG. 3, with other setting showing operations shown in FIG. 3 in the same way.

The thread change valid flag TREN sets whether the definition of the thread change is valid or invalid. During reset execution, a value indicating validness is set, with a value indicating invalidness being set after other values are set. In the present embodiment, 1 indicates validness, while 0 indicates invalidness.

The former thread FTH specifies a former thread number of the thread change. When the former thread FTH corresponds with the thread changing condition TCCND, the thread change is executed. The former thread FTH can also be configured to have no assignment. In this case, the execution of thread change is determined only by the thread changing condition TCCND.

The latter thread TTH assigns a latter thread number to which the thread is changed. When a thread change occurs, the least significant bit of the flag register FLGR that is pointed to by the thread number THN, which is set to the latter thread TTH, is set to 1. The latter thread TTH can also be configured to have no assignment. In this case, the least significant bit of the flag register FLGR is not updated.

The thread change interrupt INT instructs the CPU on whether to execute interruption during the occurrence of a thread change. In the present embodiment, when the value is 1, the interruption is generated, and when the value is 0, the interruption is not generated. In the present invention, the thread change is executed with no involvement by the CPU. This enables the notification of the termination of processing as well as the synchronization with the CPU.

The thread changing condition TCCND specifies a thread changing condition. In the present embodiment, a signal corresponding to the thread changing condition TCCND is transmitted from the reconfigurable cell array RCA to the sequencer SEQ. Comparison is made with this signal, and then the condition is determined. For example, when the processing of the Th3 in FIG. 3 is finished, a transition is made to any one of the change numbers Tr2 and Tr3. Whether it diverges to the Tr2 or to the Tr3 is determined by the thread changing condition TCCND. It becomes possible to respond to the condition branch by having the thread changing condition TCCND like this.

The value of the thread change management table that has thus far been described can be written when the thread change valid flag TREN is invalid (0). Here, whether a value is writable or unwritable is determined for each thread change number.

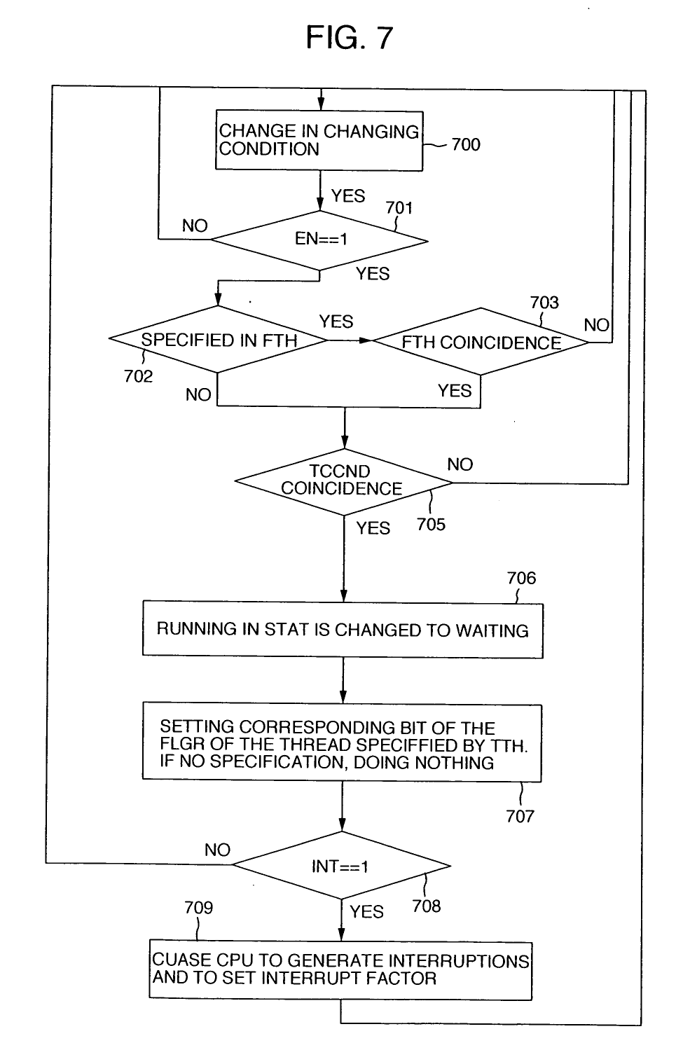

FIG. 7 is a flow chart illustrating the occurrence of the thread change and the processing for a change of the status STAT from Running to Waiting. The processing shown in the present flow chart is performed independently for each thread change.

At 700, the process of the flow chart starts with a change in thread changing condition TCCND as a trigger.

At 701, if the thread change valid flag TREN has a value (1) that indicates validness, then the process proceeds to 702, while if it has a value (0) that indicates invalidness, then the process returns to 700.

At 702, if the former thread FTH has an assignment by a former thread, then the process proceeds to 703, while if it has no assignment thereof, then the process proceeds to 705.

At 703, if the former thread FTH corresponds with a thread which is in execution, or if the thread number that has Running in the status STAT of the thread management table corresponds with the thread number specified by the former thread FTH, then the process proceeds to 705, while if there is no correspondence between them, then the process returns to 700.

At 705, if the thread changing condition TCCND corresponds with a signal that is outputted from the reconfigurable cell array RCA to the sequencer SEQ, then the process proceeds to 706, while if there is no correspondence between them, then the process returns to 700.

706 or over shows the processing when a thread change occurs.

At 706, the thread that has Running in the status STAT is changed to Waiting. This causes the reconfigurable cell array RCA to suspend computation.

At 707, the least significant bit of the flag register of the latter thread TTH is set to 1. As previously described, the least significant bit of the flag register FLGR is assigned as a thread change caused flag. Moreover, if the latter thread TTH has no thread specification, then setting to the flag register FLGR is not executed.

At 708, if “there is an interruption” (1) is set to a thread change interrupt INT, then the process proceeds to 709, while if “there is no interruption” (0) is set, then the process returns to 700.

At 709, the CPU is caused to generate an interruption, and an interrupt factor register in the sequencer SEQ is set, and then the process return to 700.

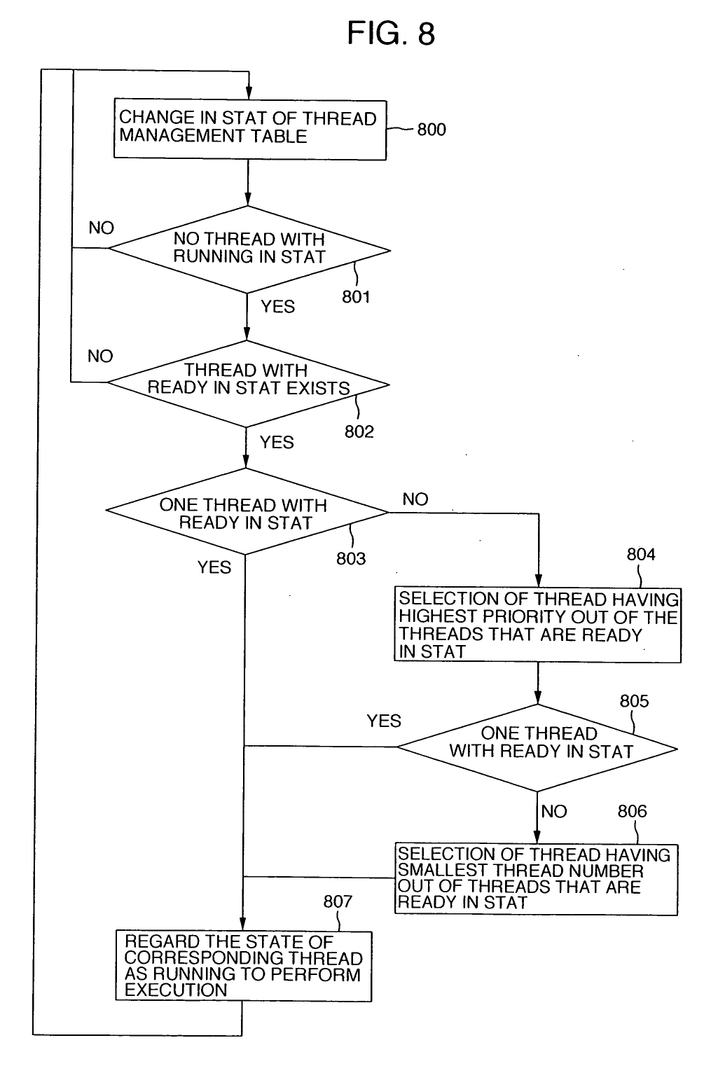

FIG. 8 is a flow chart illustrating processing for determining the thread to be executed next.

At 800, the operation of the flow chart starts with a change in any one status STAT of all the threads described in the thread management table as a trigger.

At 801, if there is a thread that has Running in the status STAT, the process returns to 800 since next thread can not be turned into Running yet. If there is no thread having Running in the status STAT, the process proceeds to 802 in order to determine a thread to be executed next. When the processing for the thread having Running is finished, the status STAT of the thread is turned into Waiting, thereby causing the flow of FIG. 8 to start at this time, and enabling efficient execution even if there are numerous threads having Ready.

At 802, if there exists no thread that has Ready in the status STAT, which means that there is no thread that has been prepared for execution, then the process returns to 800. If there exists one or more threads having Ready in the status STAT, then the process proceeds to 803.

At 803, determination is made on whether there exists one or a plurality of threads having Ready in the status STAT. If there exists one thread having Ready in the status STAT, then the process proceeds to 807, while if there exist a plurality of threads that have Ready, then the process proceeds to 804.

At 804, a thread is selected that has the highest priority among the threads that have Ready in the status STAT. The present embodiment is configured such that the smaller a value in the priority PRI is, the higher the priority is. The thread that has the highest priority is the one that has 1 in the priority PRI.

At 805, if the number of the threads selected at 804 is one, the process proceeds to 807, while if it is plural, then the process proceeds to 806.

At 806, one thread is selected that has the smallest thread number among the threads selected at 804.

At 807, the status STAT of the thread that is selected by the above flow chart is turned into running, and execution starts. Subsequently, the process returns to 800.

While description has been provided to the processing for determining the thread to be executed that is illustrated in FIG. 8, a variety of other methods are available particularly for 806. For example, they can include a method of selecting a thread in the descending order of the thread number or in a round robin fashion, a method of selecting a thread that has become a Ready state most rapidly, or the like.

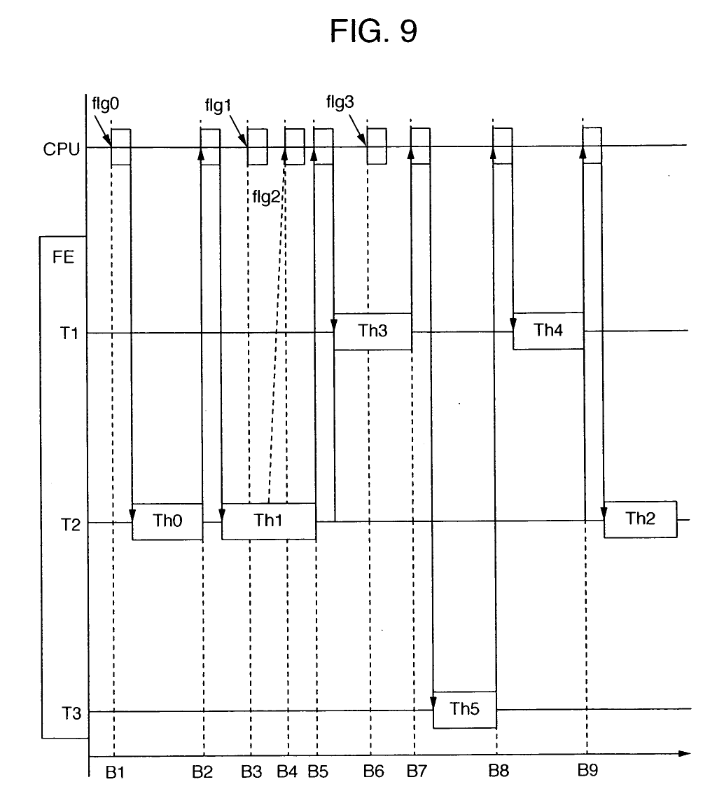

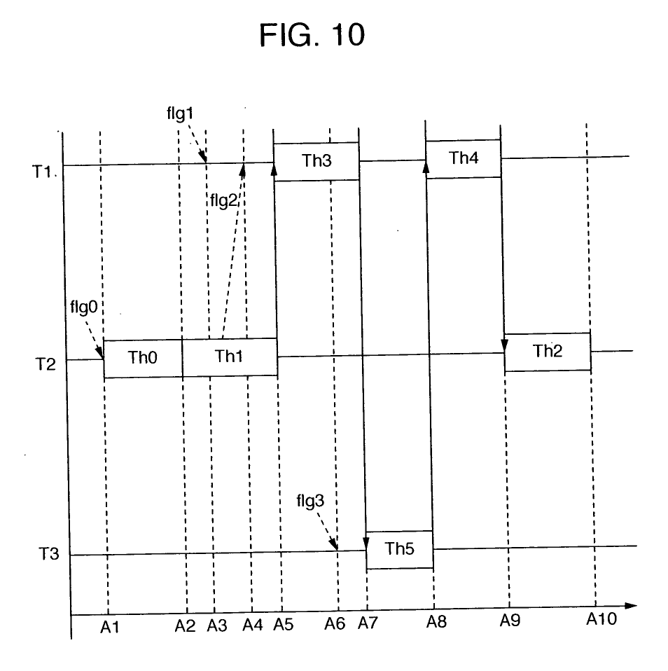

FIG. 9 is a timing chart showing how the processing shown in FIG. 3 will proceed if it is executed without the configuration of the present embodiment. This is for the purpose of comparing the processing with a case where processing of FIG. 3 is executed in the present embodiment. The top line represents an operation state of the CPU, and the lower three lines represent the operation of the dynamic reconfigurable processor FE. For the operation of the dynamic reconfigurable processor FE in particular, a different line is drawn for each task for the sake of clarity. Since the T1, T2, and T3 are executed by one dynamic reconfigurable processor FE, actually just any one of them is brought into an execution state. In FIG. 9, thin horizontal lines represent a dormant state (state in which processing is not being executed), and parts indicated by squares represent an execution state.

Even a conventional configurable processor can perform a sequential thread change as well as a thread change that includes a simple branch. However, the conventional configurable processor is not provided with such a flag from the outside and a management according to thread priority as shown in FIG. 3. Therefore, the CPU must control the thread change.

The operation shown in the timing chart of FIG. 9 will be explained below in time sequence (from the left).

The flag that is set by the Thread change Tr5 is set in advance as default.

At a timing B1, if a flg0 occurs, the CPU accesses and causes a control register of dynamic reconfigurable processor FE to execute the thread Th0. When If a flg0 is based on a factor which occurs outside the CPU, a response is made by interruption or the like.

At a timing B2, when the thread Th0 is terminated, the dynamic reconfigurable processor FE uses an interruption to notify the CPU of the termination. The CPU receives the interruption that means the termination of the thread Th0 to update the thread control information. At this point, the thread that is in an executable state is only Th1. Accordingly, the CPU accesses and causes the control register of the dynamic reconfigurable processor FE to execute the thread Th1.

At a timing B3, the CPU receives a flg1 to update the thread management information.

At a timing B4, the CPU receives a flg2 from the thread Th1 to update the thread management information. It is assumed that the notification from the thread Th1 to the CPU is performed using an interruption function of the dynamic reconfigurable processor FE. At this point, the thread Th3 is brought into an executable state.

At a timing B5, when the thread Th1 is terminated, the dynamic reconfigurable processor FE uses an interruption to notify the CPU of the termination. The CPU receives the interruption that means the termination of the thread Th1 to update the thread control information. At this point, the threads that are in the executable state are Th2 and Th3. The CPU determines the thread Th3 as a thread to be executed next based on the priority, and accesses and causes the control register of the dynamic reconfigurable processor FE to execute the thread Th3.

At a timing B6, the CPU receives a flg3 to update the thread management information. At this point, the thread Th5 is brought into an executable state.

At a timing B7, when the thread Th3 is terminated, the dynamic reconfigurable processor FE uses an interruption to notify the CPU of the termination. The CPU receives an interruption that means the termination of the thread Th3 to update the thread control information. At this point, the number of the threads that are in an executable state becomes 3 including the thread Th2, thread Th4, and thread Th5. The CPU determines the thread Th5 as a thread to be executed next based on the priority, and accesses and causes the control register of the dynamic reconfigurable processor FE to execute the thread Th5.

At a timing B8, when the thread Th5 is terminated, the dynamic reconfigurable processor FE uses an interruption to notify the CPU of the termination. The CPU receives the interruption that means the termination of the thread Th5 to update the thread control information. At this point, the number of the threads that are in an executable state becomes 2 including the thread Th2, and thread Th4. The CPU determines the thread Th4 as a thread to be executed next based on the priority, and accesses and causes the control register of the dynamic reconfigurable processor FE to execute the thread Th4.

At a timing B9, when the thread Th4 is terminated, the dynamic reconfigurable processor FE uses an interruption to notify the CPU of the termination. The CPU receives the interruption that means the termination of the thread Th4 to update the thread control information. At this point, the number of the threads that are in an executable state becomes only Th2. The CPU determines the thread Th2 as a thread to be executed next based on the priority, and accesses and causes the control register of the dynamic reconfigurable processor FE to execute the thread Th2.

As thus far described, when trying to implement such task management as shown in FIG. 3 with the conventional configuration, the CPU has to manage the threads. As a result, the overhead imposed on the CPU increases due to the thread management, interruptions, or the like. Furthermore, while computation is suspended during the thread change, the management by the CPU takes a long time for changing threads, thus making it impossible to exploit the full performance of the dynamic reconfigurable processor FE.

FIG. 10 is a timing chart showing a case where the processing illustrated in FIG. 3 is executed using the configuration of the present embodiment. According to the configuration of the present embodiment, the processing illustrated in FIG. 3 can be executed without the involvement of the CPU. Therefore, there exists no line that represents the operation of the CPU in FIG. 10. However, initialization shall start with the CPU. In order to demonstrate the operation of the dynamic reconfigurable processor FE in an easy-to-understand manner, a line is drawn for each task. Since the T1, T2, and T3 are executed by one dynamic reconfigurable processor FE, actually just any one of them is brought into an execution state. In FIG. 10, thin horizontal lines represent a dormant state (state in which processing is not being executed), and parts indicated by squares represent an execution state.

The operation shown in the timing chart of FIG. 10 will be explained below in time sequence (from the left).

First, as an initial value, the flag register FLGR of the thread Th3 is set to 0x00000001.

At a timing A1, the flg0 is set to the flag register FLGR, and becomes 0x00010000. The thread Th0 becomes Ready since the flags that become Ready are provided. With a change to Ready, the flag register FLGR of the thread Th0 is reset to become 0x00000000. Since the number of the threads that are Ready is only one at this timing, the thread Th0 becomes Running.

At a timing A2, the thread Th0 becomes Waiting due to the occurrence of a thread change Tr0, and the flag register FLGR of the thread Th1 becomes 0x00000001. Since complete flags that become Ready are provided, the thread Th1 becomes Ready. With the change to the Ready, the flag register FLGR of the thread Th1 is reset to become 0x00000000. The thread that is in an executable state at this point is just the thread Th1. Therefore, the thread Th1 becomes Running.

At a timing A3, the flag register FLGR of the thread Th3 is set to 0x00100000 by the flg1.

At a timing A4, a value is set that corresponds to a flg2 of the flag register FLGR of the threads Th1 to Th3 to become 0x01100001. Since complete flags are provided that become Ready, the thread Th3 becomes Ready. With the change to Ready, the flag register FLGR is reset to become 0x00100000. The thread that is in an executable state at this point is just the thread Th3.

At a timing A5, the thread Th1 becomes Waiting due to the occurrence of a thread change Tr1, and the flag register FLGR of the thread Th2 becomes 0x00000001. Since complete flags are provided that become Ready, the thread Th2 becomes Ready. With the change to the Ready, the flag register FLGR of the thread Th2 is reset to become 0x00000000. The threads that are in an executable state at this point are two threads including the thread Th2 and thread Th3. A thread to be executed next is determined as the thread Th3 based on the priority, and the thread Th3 becomes Running.

At a timing A6, the flag register FLGR of a thread Th5 is set to 0x10000000 by a flg3. Since complete flags are provided that become Ready, the thread Th5 becomes Ready. With the change to Ready, the flag register FLGR of the thread Th5 is reset to become 0x00000000. The threads that are in an executable state at this point are two threads, the thread Th2 and thread Th5.

At a timing A7, the thread Th3 becomes Waiting due to the occurrence of thread change Tr4, and the flag register FLGR of the thread Th4 becomes 0x00000001. Since complete flags are provided that become Ready, the thread Th4 becomes Ready. With the change to the Ready, the flag register FLGR of the thread Th4 is reset to become 0x00000000. The threads that are in an executable state at this point are three threads, the thread Th2, thread Th4, and thread Th5. The thread to be executed next is determined based on the priority as the thread Tr5, and the thread Th5 becomes Running.

At a timing A8, the thread Th5 becomes Waiting due to the occurrence of a thread change Tr6. Since no specification is included in the latter thread TTH, the flag register FLGR of the thread change Tr6 is not set by the thread change. The threads that are in an executable state at this point are two threads, the thread Th2 and thread Th4. A thread to be executed next is determined as the thread Tr4 based on the priority, and the thread Th4 becomes Running.

At a timing A9, the thread Th4 becomes Waiting due to the occurrence of a thread change Tr5, and the flag register FLGR of the thread Th3 becomes 0x00100001. The thread that is in an executable state at this point is just the thread Th2. Therefore, the thread Th2 becomes Running.

Since the present embodiment operates as described in FIG. 10, the dynamic reconfigurable processor FE is capable of autonomously managing the threads without the control by the CPU associated with thread changes, thus making it possible to reduce the latency time involved in the communication with the CPU as well as overhead. In addition, since the control processing executed by the CPU is reduced, the performance of the entire chip will be enhanced.

Having such a sequence as described in the present embodiment enables the flag register to manage whether each thread is in an executable state, and enables multitask processing that selects one thread from a plurality of executable threads based on the priority to execute the selected thread. Moreover, it is possible to update the flag register both from the inside and outside the dynamic reconfigurable processor and also to implement processing with ease in synchronization with other modules.

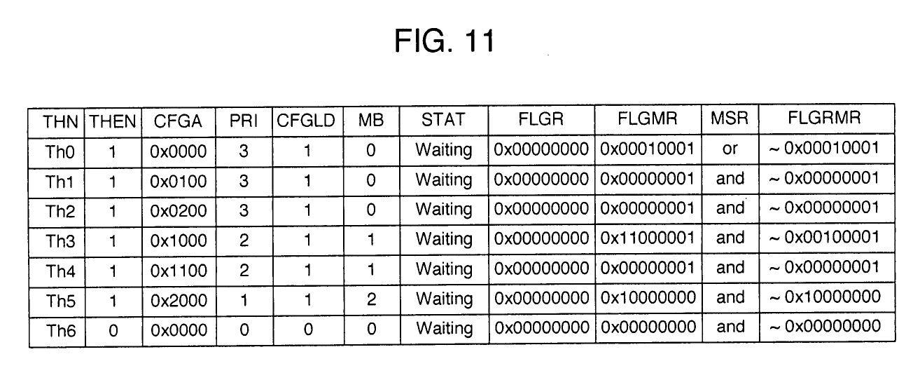

FIG. 11 is a view showing a second configuration of the thread management table shown in FIG. 4. Since parts of FIG. 11 represented by the same reference numerals as those of FIG. 4 function in the same way, the description thereof will be abbreviated. The thread management table further includes a memory bank assignment MB.

The memory bank assignment MB assigns an area (bank) that can be used by the thread of a local memory included in a dynamic reconfigurable cell array RCA. For example, when accessing an address of 100 via the configuration data with the memory bank assignment MB=0, access is made to the address of 100 of bank 0. When accessing an address of 100 via the configuration data with the memory bank assignment MB=1, access is made to the address of 100 of bank 1. This enables sharing or isolating a memory between tasks. In the memory bank assignment shown in FIG. 11, a bank is assigned to each task so as to prevent each task from competing with each other in using the memory area.

The present function facilitates the memory management and thereby facilitates task management. Additionally, the present function enables one reconfigurable cell array RCA to easily implement the execution of differently designed tasks.

The present invention has thus far been described based on the embodiments. However, it should be noted that the present invention can be modified in a variety of other ways within a scope that does not depart from the spirit of the invention.

According to the dynamic reconfigurable processor of the present invention, multitasking can be achieved without using the function of the controlling processor, thus enabling the achievement of target processing with a very small overhead.

It should be further understood by those skilled in the art that although the foregoing description has been made on embodiments of the invention, the invention is not limited thereto and various changes and modifications may be made without departing from the spirit of the invention and the scope of the appended claims.

1. A semiconductor device comprising a dynamic reconfigurable processor that changes functions thereof by changing configuration data and executes a plurality of threads in a time-sharing mode, wherein said dynamic reconfigurable processor has a thread management table that has a plurality of flag registers for indicating whether corresponding threads are in an executable state for each thread, and a sequencer that controls said thread change based on the information of said thread management table, and wherein said sequencer changes said threads by referring to the contents of said plurality of flag registers.

2. The semiconductor device according to claim 1, further comprising a module for executing processing in parallel with the processing by said dynamic reconfigurable processor, and a bus for connecting said module and said dynamic reconfigurable processor, wherein said flag register is rewritten by the dynamic reconfigurable processor itself and said module.

3. The semiconductor device according to claim 1, wherein each of said plurality of flag registers has a plurality of bits that hold conditions for bringing corresponding threads into the executable state, and said thread management table has a plurality of flag mask registers for each thread that are referred to when bringing the corresponding threads into the executable state.

4. The semiconductor device according to claim 1, wherein said thread management table further has a priority flag for specifying a priority for each thread, and said sequencer refers to the value of the priority flag when the plurality of threads are in an executable state to bring the thread having a high priority into the execution state.

5. The semiconductor device according to claim 1, further comprising a memory for storing said configuration data, and a bus for connecting said memory and said dynamic reconfigurable processor, wherein said dynamic reconfigurable processor further has a configuration buffer in which said configuration data stored in said memory is loaded, and said thread management table has a plurality of configuration load flags for each thread that indicate whether said configuration data is stored in said configuration buffer.

6. The semiconductor device according to claim 5, wherein said thread management table has a plurality of configuration address registers for each thread that hold the address of said configuration buffer for storing said configuration data corresponding to threads.

7. The semiconductor device according to claim 1, wherein said dynamic reconfigurable processor further has a thread change management table for managing former thread information as well as latter thread information for each transition state, and said sequencer uses the information stored in said thread change management table to determine a thread to be executed next when the processing of the thread in execution is finished.

8. The semiconductor device according to claim 7, wherein said thread change management table holds a thread changing condition for each transition state, and said sequencer brings a corresponding latter thread into an executable state when said former thread information corresponds with said thread changing condition.

9. The semiconductor device, comprising a dynamic reconfigurable processor that changes functions thereof by changing configuration data and executes a plurality of threads in a time-sharing mode, wherein each of said plurality of threads is brought into an executable state when one or a plurality of conditions is or are provided, said dynamic reconfigurable processor has a flag registers for each indicating whether each of said one or plurality of conditions is satisfied, and a thread management table having a plurality of flag mask registers for each thread that specify a corresponding thread to be brought into an executable state when which condition of said plurality of bits is satisfied.

10. The semiconductor device according to claim 9, said dynamic reconfigurable processor further has a sequencer for determining a thread to be changed based on the information of said flag register and said flag mask register.
